(19) United States
(12) Patent Application Publication
(10) Pub. No.: US 2013/0179169 A1
(43) Pub. Date: Jul. 11, 2013

(54) CHINESE TEXT READABILITY ASSESSING SYSTEM AND METHOD

(71) Applicants: Yao-Ting Sung, Taipei City (TW); Ju-Ling Chen, Taipei City (TW)

(72) Inventors: Yao-Ting Sung, Taipei City (TW); Ju-Ling Chen, Taipei City (TW)

(73) Assignee: NATIONAL TAIWAN NORMAL UNIVERSITY, Taipei City (TW)

(21) Appl. No.: 13/542,019

(22) Filed: Jul. 5, 2012

(30) Foreign Application Priority Data
Jan. 11, 2012 (TW) 101101049

(51) Int. Cl. G10L 15/04

(52) U.S. Cl. 704/254; 704/E15.005

(57) ABSTRACT

A Chinese text readability assessing system analyzes and evaluates the readability of text data. A word segmentation module compares the text data with a corpus to obtain a plurality of word segments from the text data and provide part-of-speech settings corresponding to the word segments. A readability index analysis module analyzes the word segments and the part-of-speech settings based on readability indices to calculate index values of the readability indices in the text data. The index values are inputted to a readability mathematical model in a knowledge-evaluated training module, and the readability mathematical model produces a readability analysis result. Accordingly, the Chinese text readability assessing system of the present invention evaluates the readability of Chinese texts by word segmentation and the readability indices analysis in conjunction with the readability mathematical model.

### FIELD OF THE INVENTION

The present invention relates to Chinese text readability assessing systems and methods, and, more particularly, to a Chinese text readability assessing system and method that analyze and evaluate the readability of Chinese texts.

### BACKGROUND OF THE INVENTION

In recent years, more and more people around the world are learning Chinese, and Chinese learning business is flourishing. Coupled with the rapid growth of online information, learning sources are not limited to school teachers. Learners can also learn on their own through the Internet, books, articles and the like. In any case, good teaching materials are essential to effectively learning the Chinese language.

The readability of a text plays an important role in determining whether the text is a good teaching material. Readability refers to the level of comprehension of a reading material by a reader (Dale & Chall, 1948; Klare, 1963, 2000; McLaughlin, 1969). Texts of high readability generally contain certain features, such as containing contents that are easier to comprehend (e.g., common words with low complexity and non-technical, clear meaning); containing few pronouns and compound words or simple structure in a sentence; containing contents in line with readers' prior knowledge; with reference back to the previous paragraphs; providing relevant knowledge; and with less unrelated interference messages, etc. (Klare, 1963, 2000; van den Broek & Kremer, 2000). From the foregoing, texts of high readability are easily readable by the readers. Such texts use specific words and words pertaining to everyday life, or low complexity sentences, for example, to reduce the reader's cognitive load. Thus, if text readability can be assessed and analyzed, readers will be provided with appropriate learning materials.

European and American researchers have built a sophisticated online text analysis system (Coh-Metrix), which provides an objective and quantitative analysis of text features. However, the system is used in alphabetic systems only. Chinese differs from the alphabetic systems significantly, so the system cannot be applied to Chinese. Moreover, for the Chinese text analysis, a series of Chinese readability formulae were developed by Chinese scholars, but they were outdated and were not suitable for modern texts. In summary, the present Chinese readability researches still have the following limitations to be overcome: (1) readability indices consistent with Chinese characteristics and context of the modern language are yet to be developed; (2) readability formulae in the past only select a few shallow language features; and (3) development of an effective readability mathematical model is needed.

Therefore, there is a need to provide learners or educators with a more effective readability mathematical model for text readability analysis.

### SUMMARY OF THE INVENTION

In light of the foregoing drawbacks, an objective of the present invention is to provide a Chinese text readability assessing system and method that provides readability analysis result through word segmentation, readability index analysis and readability mathematical model construction.

In accordance with the above and other objectives, the present invention provides a Chinese text readability assessing system applicable to and executable by a data processing apparatus. The Chinese text readability assessing system a word segmentation for comparing text data with a corpus to generate a plurality of word segments from the text data and part-of-speech settings corresponding to the word segments, a readability index analysis module for analyzing the word segments and the part-of-speech settings based on one or more readability indices in the text data to calculate index values of the readability indices, and a knowledge-evaluated training module including a predetermined readability mathematical model that receives the index values and generates an analysis result accordingly.

In an embodiment, the part-of-speech settings include part-of-speech tags of the word segments, word segment information, and part-of-speech tag information corresponding to the word segments generated by the word segmentation module. The readability index belongs to at least one of lexical features, semantic features, syntactic features and text cohesion features.

In another embodiment, the readability mathematical model can be a general linear or non-linear model. The non-linear readability mathematical model can be formed by integrating artificial intelligence classifiers, such as a support vector machine (SVM), an artificial neural network (ANN), a decision tree, a Bayesian network and genetic programming (GP).

The present invention also proposes a Chinese text readability assessing method applicable to and executable by a data processing apparatus. The Chinese text readability assessing method includes the following steps of: (1) comparing a text data with a corpus to generate a plurality of word segments from the text data; (2) providing part-of-speech settings for the word segments; (3) corresponding the word segments and the part-of-speech settings to one or more readability indices to calculate index values of the readability indices in the text data; and (4) obtaining an analysis result of the text data readability based on the index values.

Compared to the prior art, the Chinese text readability assessing system and method of the present invention performs word segmentation and part-of-speech settings on a Chinese text, calculates index data relevant to the word segments in the Chinese text based on predetermined readability indices, and obtains a readability result. The present invention takes advantage of word segmentation and readability indices consistent with existing Chinese characteristics and the modern language to provide a better readability assessment mechanism. Thus, the automatic Chinese text readability analysis and assessment facilitates text readability research and provides suitable text for readers, while allowing researchers and teachers to objectively and scientifically conduct text researches and develop teaching materials.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram depicting a Chinese text readability assessing system according to the present invention;

FIG. 2 is a block diagram illustrating various functions of a word segmentation module performed on a text data according to the present invention;

FIG. 3 is a diagram illustrating conversion of non-linear data into feature space using a kernel function by a support vector machine (SVM);

FIG. 4 is a block diagram illustrating the process for classifying text using a mathematical model constructed with the SVM; and

FIG. 5 is a flowchart illustrating a Chinese text readability assessing method according to the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

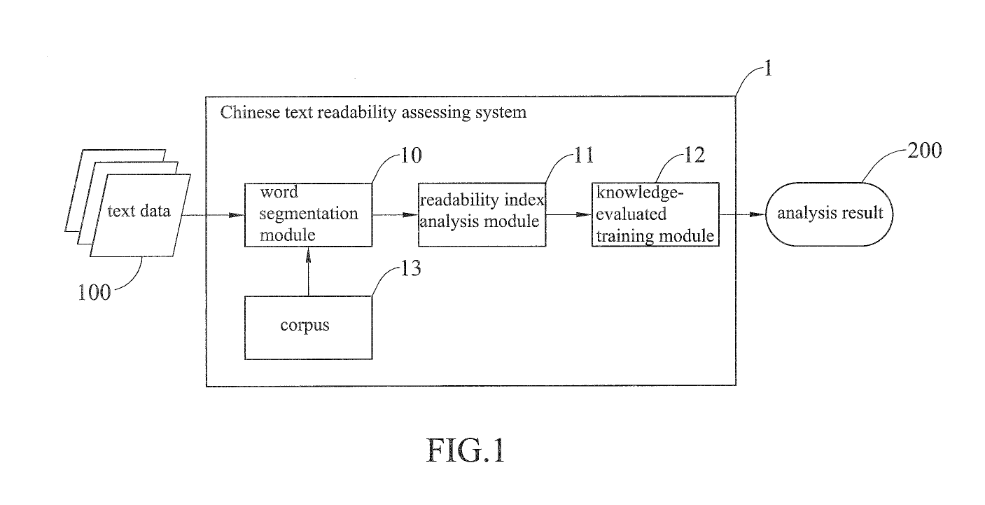

Referring to FIG. 1, a block diagram illustrating a Chinese text readability assessing system according to the present invention is shown. The Chinese text readability assessing system 1 segments and analyzes words of text data 100. The Chinese text readability assessing system 1 includes a word segmentation module 10, a readability index analysis module 11 and a knowledge-evaluated training module 12.

In an embodiment, the Chinese text readability assessing system 1 can be applied to a data processing apparatus, such as a processor, a memory, a storage unit and an operating system, and is executable by the data processing apparatus to analyze the readability of Chinese texts. In an embodiment, the Chinese text readability assessing system 1 sources Chinese texts from a book, electronic files over the Internet, or the like. In an embodiment, the data processing apparatus is a computer, a server, a cloud server, or the like.

The word segmentation module 10 segments words of the text data 100 by comparing the text data 100 with a corpus 13 to generate a plurality of word segments from the text data 100, and generate part-of-speech settings corresponding to the word segments. More specifically, the word segmentation module 10 provides word segmentation process on the text data 100 by segmenting words in the Chinese content of a whole article or passage and giving tags to facilitate subsequent analysis of the text data 100. Word segmentation is important for text analysis. Incorrect segmentation leads to incorrect tagging of parts of speech, such that the construed semantics deviate from the original semantics. In an embodiment, the above corpus includes Chinese corpus and balanced corpus of modern Chinese from Academia Sinica, Chinese sentence structure tree database, and the like.

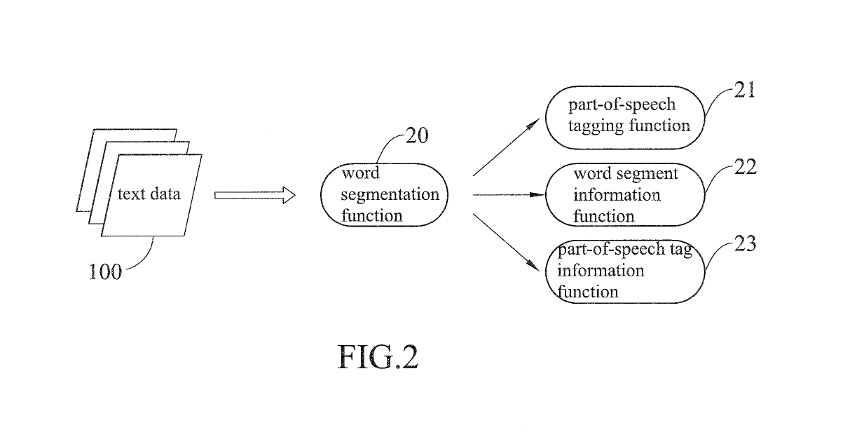

After generating the word segments, the word segmentation module 10 provides part-of-speech settings for these word segments. More particularly, part-of-speech settings may include part-of-speech tags of the word segments, and information recording the word segments and the part-of-speech tags corresponding to the word segments generated by the word segmentation module. That is, the word segmentation module 10 has the functions of segmenting words, tagging parts of speech and generating information on word segments and on part-of-speech tags. As shown in FIG. 2, a block diagram illustrating the various functions of the word segmentation module 10 performed on the text data according to the present invention is shown. Refer to FIGS. 1 and 2. After processed by a word segmentation function 20, numerous word segment data are generated from the text data 100. These word segment data are processed by a part-of-speech tagging function 21, a word segment information function 22 or a part-of-speech tag information function 23, thereby completing the processes of word segmentation and part-of-speech tagging.

The readability index analysis module 11 analyzes the word segments and the part-of-speech settings using readability indices predetermined in the text data in order to calculate and obtain index values of the readability indices. As described previously, the predetermined readability indices are used to analyze and calculate the word segments and the part-of-speech settings generated by the word segmentation module 10 and obtain the index values of the readability indices. In an embodiment, the readability index is at least one selected from the group consisting of lexical features, semantic features, syntactic features and text cohesion features. The readability indices are features characterizing text readability such as words, sentences, difficult words, pronouns, conjunctions, negation words and the like in the text data 100.

In an embodiment, the readability indices can be characterized into five categories: (1) text basic description features, such as the number of characters, the number of words, the number of sentences, etc.; (2) lexical features, such as diversity, frequency, or length of vocabulary, etc.; (3) semantic features, such as semantic, underlying semantic, etc.; (4) syntactic features, such as average number of words in a sentence and proportions in a single sentence, etc.; and (5) text cohesion features, such as pronouns and conjunctions, etc.

In an embodiment, 65 indices are developed and classified into the above five categories. That is, the Chinese text readability assessing system 1 provides five categories of indices including lexical indices, semantic indices, syntactic indices, text cohesion indices and text basic description indices. Each of the categories is an important component in text comprehension. The indices overall provides more accurate and extensive readability concepts for characterizing the readability of a text. The following table lists various indices currently developed and their categories and conceptual definition.

TABLE 1
Classifications and Conceptual Definition of Readability Indices

| Index | Classification | Conceptual definition |
|---|---|---|
| Number of characters | Lexical | Total number of characters |
| Number of words | Lexical | Total number of words |
| Number of nouns | Lexical | Total number of nouns |
| Number of adjectives | Lexical | Total number of adjectives |
| Number of adverbs | Lexical | Total number of adverbs |
| Number of verbs | Lexical | Total number of verbs |
| Type-Token Ratio | Lexical | Degree of diverse words |
| Content word density | Lexical | Density of content words |
| Verb diversity | Lexical | The degree of diverse types of verbs used |
| | | in the text |
| Average word frequency | Lexical | Average word overlapping |
| Average content word | Lexical | Degree of content words overlapped in |
| frequency in logarithmic | | whole text |
| Average content word | Lexical | Degree of familiarity of notional words in |
| frequency in domain in | | whole text |
| Logarithmic | | |
| Logarithmic mean of word | Lexical | Logarithmic mean of word frequency |
| frequency corresponding to | | according to Academia Sinica database |
| external database | | |
| Logarithmic mean of content | Lexical | Logarithmic mean of content word |
| word frequency corresponding | | frequency according to Academia Sinica |
| to external database | | database |
| Number of difficult words | Lexical | Total number of words not included in the |
| | | common vocabulary list |
| Minimum word frequency in | Lexical | The lowest frequency of word per |
| each sentence | | sentence |
| Number of characters with low | Lexical | Total number of characters containing |
| stroke counts | | from 1 to 10 strokes |
| Number of characters with | Lexical | Total number of characters containing |
| median stroke counts | | from 11 to 20 strokes |
| Number of characters with | Lexical | Total number of characters containing |
| high stroke counts | | from 11 to 20 strokes |
| Average character strokes | Lexical | Average number of character strokes |
| Number of two-character | Lexical | Total number of two-character words |
| words | | |
| Number of three-character | Lexical | Total number of three-character words |
| words | | |
| Number of content words | Semantic | Total number of content words |
| Number of negation | Semantic | Total number of negation words |
| Number of sentences with | Semantic | Number of sentence containing words |
| complex semantic categories | | with complex semantic categories |
| Number of complex semantic | Semantic | Number of words containing complex |
| categories | | semantic categories |
| Number of intentional words | Semantic | Total number of words with “intentional” |
| | | meaning |
| Density of proper nouns | Semantic | Ratio of proper nouns to words |
| Density of words in natural | Semantic | Density of words with specific meanings |
| science field | | related to natural science field/domain |
| Ratio of content/function | Semantic | Ratio of content words to function words |
| words | | |
| Density of words in social | Semantic | Density of words with specific meanings |
| science field | | in social science field/domain |
| LSA grade level | Semantic | Predict the grade level of text by LSA |
| Average sentence length | Syntactic | Sentence length |
| Ratio of simple sentence | Syntactic | Ratio of “simple sentence” structure |
| Number of noun phrase | Syntactic | Number of modifiers per NP |
| modifiers | | |
| Noun phrase ratio | Syntactic | Ratio of noun phrases |
| Subject length | Syntactic | The length of subject |
| Pronoun ratio | Syntactic | Ratio of pronouns to words |
| Noun ratio | Syntactic | Ratio of nouns to words |
| Ratio of passive structure | Syntactic | Ratio of passive structures |
| Average number of | Syntactic | Average number of prepositional phrases |
| prepositional phrases | | in each sentence |
| Number of complex sentence | Syntactic | Total number of sentences with |
| structures | | complicated structures |
| Syntactic structure variation | Syntactic | The degree of different structures |
| | | occurred in sentence |
| Parallelism | Syntactic | Rhetorical features of parallelism in text |
| Number of pronouns | Text | Total number of pronouns |
| | cohesion | |
| Number of personal pronouns | Text | Total number of personal pronoun |
| | cohesion | |
| Number of first-person | Text | Total number of first-person pronouns |
| pronouns | cohesion | |
| Number of third-person | Text | Total number of third-person pronouns |
| pronouns | cohesion | |
| Number of conjunctions | Text | Total number of conjunctions |
| | cohesion | |
| Number of positive | Text | Total number of positive conjunctions |
| conjunctions | cohesion | |
| Number of negative | Text | Total number of negative conjunctions |
| conjunctions | cohesion | |
| Number of transitional | Text | Total number of transitional conjunctions |
| conjunction | cohesion | |
| Number of causal conjunctions | Text | Total number of causal conjunctions |
| | cohesion | |
| Number of hypothetical | Text | Total number of hypothetical conjunctions |
| conjunctions | cohesion | |
| Number of conditional | Text | Total number of conditional conjunctions |
| conjunctions | cohesion | |
| Number of purpose | Text | Total number of purpose conjunctions |
| conjunctions | cohesion | |
| Degree of adjacent noun | Text | The degree of nouns overlap in adjacent |
| overlap | cohesion | sentences that share the same nuns |
| Degree of adjacent content | Text | The degree of content words overlap in |
| word overlap | cohesion | adjacent sentences that share the same |
| | | content words |
| Correlation of latent meaning | Text | The degree of LSA overlap of adjacent |
| in adjacent sentences | cohesion | sentences in text |
| Correlation of latent meaning | Text | The degree of LSA overlap of random |
| in text | cohesion | paired sentences in text |
| Correlation of latent meaning | Text | The degree of LSA overlap of random |
| of verbs in adjacent sentences | cohesion | paired sentences in text |
| Metaphor | Text | Rhetorical property of referring one thing |
| | cohesion | to another thing |
| Number of paragraphs | Text basic | Total number of paragraphs |
| | description | |
| Average paragraph length | Text basic | Average number of sentence in each |
| | description | paragraph |
| Number of sentences | Text basic | Total number of sentences |
| | description | |

In an embodiment, the above Chinese text readability indices can be regarded as the predicator variables, while a suitable grade for a text is regarded as the criterion variable. The above readability indices indicating readabilities of texts can provide suitable determination basis. However, the settings for the readability indices can be modified based on needs; this embodiment is only a preferred embodiment, and the readability indices can be adjusted or other readability indices can be added.

The knowledge-evaluated training module 12 generates an analysis result 200 based on these index values via a readability mathematical model. The readability mathematical model can be developed through a knowledge-evaluated training system (KETS) and constructed using these readability indices. Thus, after the readability index analysis module 11 calculates the index values of the readability indices, the index values can be integrated through knowledge-evaluated training to form a suitable readability mathematical model for generating the final analysis result 200. As such, the readability of the text data 100 is known. Furthermore, the readability mathematical model can be a general linear or non-linear model. Based on testing results performed by the inventor, it is found that non-linear models have higher accuracy in readability prediction than general linear ones. Therefore, this embodiment is described in the context of a readability mathematical model that is generated non-linearly.

The non-linear readability mathematical model adopted by this embodiment is formed by integrating artificial intelligence (AI) classifiers such as a support vector machine (SVM), wherein the artificial intelligence classifiers further include any one of artificial neural network (ANN), decision tree, Bayesian network or genetic programming (GP) to accurately classify text data. SVM is an AI learning machine used in the present academic, offering an algorithm for data classification that uses structural risk minimization (SRM) as the theoretical basis (Vapnik, 1998; Yeh, Chi, & Hsu, 2010). SVM uses hyperplane(s) to classify data and memorizes data characteristics, and after training and learning, it can be used to predict data class.

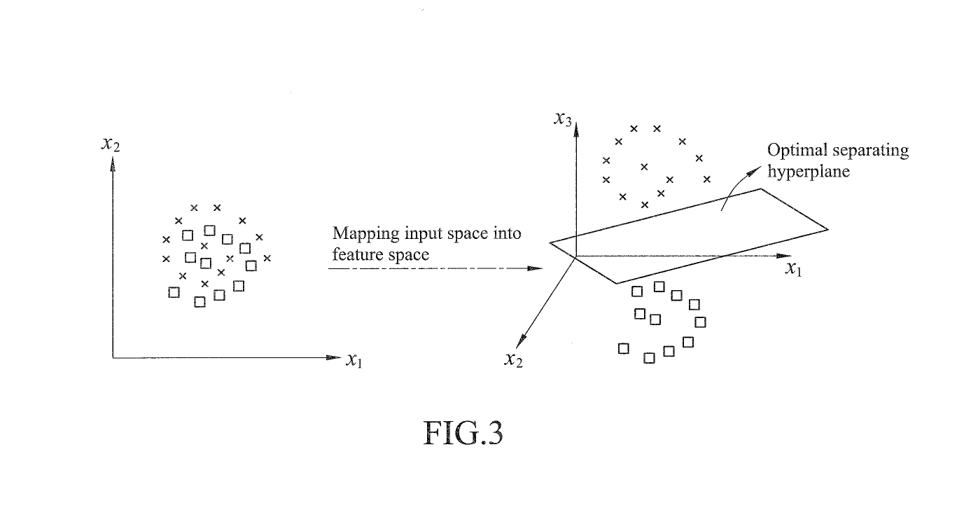

During SVM model training, an optimal separating hyperplane (OSH) is found for separating data. However, sometimes data cannot be separated by a linear OSH in the current dimension. In this case, SVM may project data to higher dimensional space or feature space using a kernel function. As shown in FIG. 3, a 2-D coordinate on the left of the diagram cannot be separated by a linear OSH, so the data is mapped to a feature space, so the data can be more distributed, as shown by a 3-D coordinate on the right of the diagram, and a OSH for classification can then be found more easily. Common SVM kernel functions can be linear, polynomial, Radial Basis Function (RBF) or sigmoid. However, SVM kernel functions are not the main technical features of the present invention, so they will not be described any further (refer to Vapnik (1998) for more information on SVM).

In summary of the above, the present invention assesses readability through word segmentation and indices analysis of text data. In another embodiment, the word segmentation module and the readability index analysis module above can be combined to form a Chinese readability index explorer (CRIE), thereby providing word segmentation, part-of-speech tagging and readability index values. This CRIE is further combined with the knowledge-evaluated training system to form the Chinese text readability assessing system.

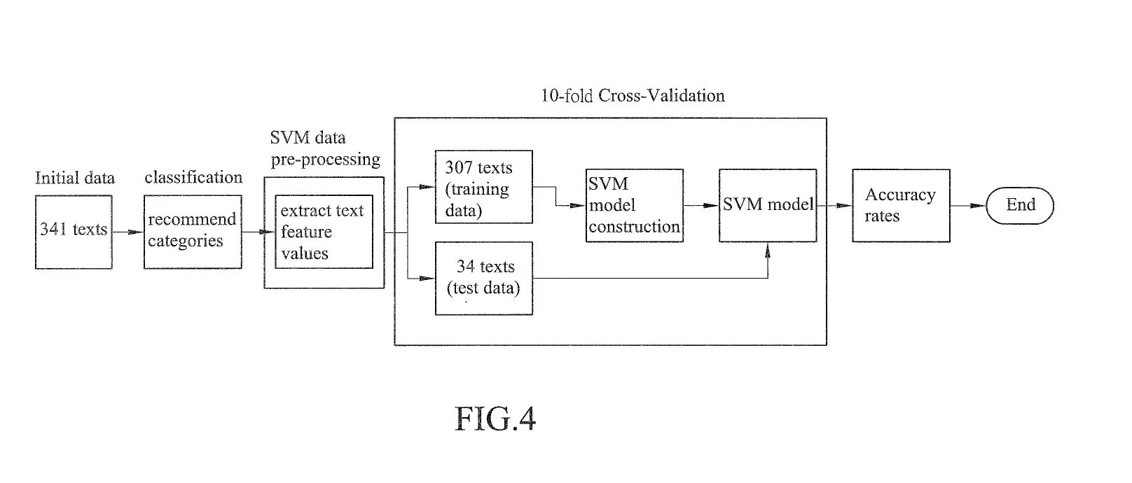

In order to explain the method for constructing a SVM readability mathematical model, refer to FIG. 4, in which a block diagram illustrates the process for classifying text using a mathematical model constructed with a SVM. However, the method below is merely an exemplary embodiment of the present invention and is not the only way for constructing a readability mathematical model. Moreover, the number of texts used is not limited that described herein.

In FIG. 4, training data are prepared. 341 texts for a training model are divided into training texts (about 75%, 307 texts) and test texts (about 25%, 34 texts), the suitable school grade and term for each of the texts are defined, and the readability indices are extracted from each of the texts. Thereafter, for training the model, defined training data are input to the SVM. Since better results can be obtained through cross-validation, so the embodiment adopts n-fold Cross-Validation (Vapnik, 1998), i.e., a 10-fold Cross-Validation process for SVM model training by trial and error. The operations are as follow. The 341 data are divided into ten groups, each of which has 34 texts. For a first iteration, a first group among the 10 groups is regarded as test data, while the other nine groups are regarded as training data. Then, for a second iteration, a second group among the ten groups is regarded as test data, while the other nine groups are regarded as training data. Ten similar iterations are performed to obtain ten accuracy rates. The ten accuracy rates are averaged to arrive at a final accuracy rate, which indicates the accuracy rate of the model trained by the SVM. By using the above method, a readability mathematical model with high accuracy necessary for the present invention is obtained, which facilitates the analysis for Chinese text readability.

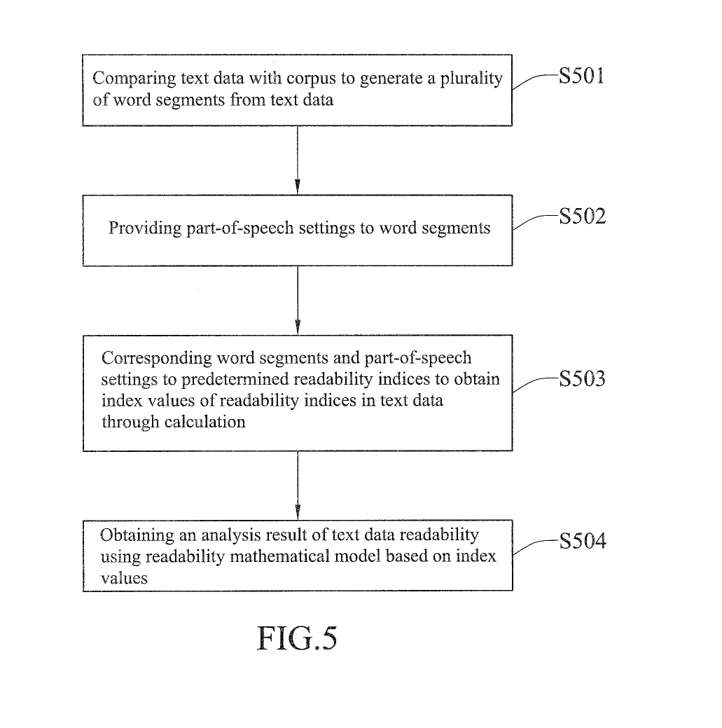

A Chinese text readability assessing method is described with respect to FIG. 5 in conjunction with the Chinese text readability assessing system shown in FIG. 1.

In step S501, a text data is compared with a corpus to generate a plurality of word segments from the text data. The text data is compared with a corpus to generate a plurality of word segments from the text data. Suitable word segmentation facilitates subsequent analysis, such that content meaning of the text data can be obtained. Then, the method proceeds to step S502.

In step S502, part-of-speech settings are provided to the word segments. More specifically, in order for the word segments to be analyzable, part-of-speech settings are provided to the word segments based on predetermined data. For example, part-of-speech tags are assigned to the word segments, or word segment information or part-of-speech tag information corresponding to a word segment and a part-of-speech tag are generated. Then, the method proceeds to step S503.

In step S503, the word segments and the part-of-speech settings correspond to predetermined readability indices, so as to calculate index values of the readability indices in the text data. In order to obtain the text data readability, index values of the readability indices in the text data are calculated based on the word segments, the part-of-speech tags, the word segment information and the part-of-speech tag information with reference to predetermined readability indices. Then, the method proceeds to step S504.

In step S504, a readability mathematical model obtains an analysis result of the text data readability from these index values. In an embodiment, the readability mathematical model is a general linear or a non-linear model. In step S504, the readability mathematical model obtains the final analysis result (i.e., the readability assessment of the text data) is obtained based on the index values obtained in step S503. For example, a non-linear readability mathematical model can be used for text analysis, wherein the non-linear readability mathematical model is formed by integrating the AI classifiers so as to provide an accurate classification of text data. As for the construction of the readability mathematical model, explanations have already been given above, and will not be repeated again.

In summary, the Chinese text readability assessing system and method of the present invention calculates index data relevant to a Chinese text through word segmentation and readability index determination of the text data, and obtains Chinese text readability data through the readability mathematical model in the knowledge-evaluated training module. The Chinese text readability assessing system and method are not only consistent with existing Chinese and modern language characteristics, but are also capable of providing suitable Chinese text for readers. Moreover, the Chinese text readability analysis and assessment allows researchers and teachers to objectively and effectively conduct text researches and develop teaching materials.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A Chinese text readability assessing system applicable to and executable by a data processing apparatus, the Chinese text readability assessing system comprising:
a word segmentation module comparing text data with a corpus to generate a plurality of word segments from the text data and part-of-speech settings corresponding to the word segments;
a readability index analysis module analyzing the word segments and the part-of-speech settings based on one or more readability indices in the text data to calculate index values of the readability indices; and
a knowledge-evaluated training module including a predetermined readability mathematical model that receives the index values and generates an analysis result.

2. The Chinese text readability assessing system of claim 1, wherein the part-of-speech settings include part-of-speech tags of the word segments, and word segment information and part-of-speech tag information corresponding to the word segments generated by the word segmentation module.

3. The Chinese text readability assessing system of claim 1, wherein the readability mathematical model is a general linear or non-linear model.

4. The Chinese text readability assessing system of claim 3, wherein the non-linear readability mathematical model is formed by integrating artificial intelligence classifiers.

5. The Chinese text readability assessing system of claim 4, wherein the artificial intelligence classifiers include any one of support vector machine (SVM), artificial neural network (ANN), decision tree, Bayesian network and genetic programming (GP).

6. The Chinese text readability assessing system of claim 1, wherein the readability index belongs to at least one of lexical features, semantic features, syntactic features and text cohesion features.

7. A Chinese text readability assessing method applicable to and executable by a data processing apparatus, the Chinese text readability assessing method comprising the following steps of:
(1) comparing text data with a corpus to generate a plurality of word segments from the text data;
(2) providing part-of-speech settings for the word segments;
(3) corresponding the word segments and the part-of-speech settings to one or more readability indices to calculate index values of the readability indices in the text data; and
(4) obtaining an analysis result of the text data readability using a readability mathematical model based on the index values.

8. The Chinese text readability assessing method of claim 7, wherein providing part-of-speech settings in step (2) includes assigning part-of-speech tags to the word segments, and generating word segment information and part-of-speech tag information corresponding to the word segments.

9. The Chinese text readability assessing method of claim 7, wherein the readability mathematical model is a general linear or non-linear model.

10. The Chinese text readability assessing method of claim 9, wherein the non-linear readability mathematical model is formed by integrating artificial intelligence classifiers including any one of support vector machine (SVM), artificial neural network (ANN), decision tree, Bayesian network and genetic programming (GP).
